(19) United States
(12) Patent Application Publication
(10) Pub. No.: US 2021/0228325 A1
(43) Pub. Date: Jul. 29, 2021

(54) FULL ARCH DENTAL TREATMENT DEVICES AND SYSTEMS

(71) Applicant: CAO Group, Inc., West Jordan, UT (US)

(72) Inventors: Steven D. Jensen, South Jordan, UT (US); Densen B. Cao, Sandy, UT (US)

(21) Appl. No.: 17/232,020

(22) Filed: Apr. 15, 2021

Related U.S. Application Data
(63) Continuation of application No. 12/944,937, filed on Nov. 12, 2010, now abandoned.
(60) Provisional application No. 61/281,027, filed on Nov. 12, 2009.

(51) Int. Cl. A61C 19/06

(52) U.S. Cl. CPC A61C 19/063; A61C 19/066

(57) ABSTRACT

Example embodiments of the present invention include methods, devices, and systems that provide effective dental treatments to all tooth surfaces of the entire dental arch. In particular, embodiments of the present invention include treatment devices and systems that are capable of treating the entire arch by covering and delivering active ingredients to the front, back, and top surfaces of each of the teeth of the full dental arch. Moreover, example embodiments of the present invention provide treatment devices and systems that are capable of treating the gingival margin and gums of an entire arch.

### TECHNICAL FIELD OF THE INVENTION

The present disclosure generally relates dental treatment devices, and in particular, dental treatment devices that are attached, temporarily or otherwise, to the teeth.

### CROSS-REFERENCE TO RELATED APPLICATIONS

This application claims priority as a Continuation of prior filed U.S. patent application Ser. No. 12/944,937, filed Nov. 12, 2010, which in turn claims the benefit of U.S. Provisional Application No. 61/281,027, filed Nov. 12, 2009, which is incorporated herein by reference in its entirety.

### BACKGROUND OF THE INVENTION

Conventional dental whitening strips usually include a backing layer that is made from a flexible thin film of plastic (or similar material). The backing layer acts as an insoluble first layer to which a whitening gel is applied as second layer to one side of the backing layer. The whitening gel acts as a mild adhesive and sticks the insoluble backing material to the teeth, while the backing material acts as a barrier to saliva in order to protect the whitening gel from dilution. The whitening gel chemically whitens the teeth while the gel remains in contact with the teeth and until the user removes the dental whitening strip.

Conventional dental whitening strips are designed to only cover the portion of an individual's teeth that is viewable during normal interactions with other people (i.e., the front surface of the front teeth, and primarily the front surface of the front top teeth). Thus, both the width and length of conventional dental whitening strips typically do not allow an entire individual tooth to be covered with the dental whitening strip (i.e., both the front, back, and top surfaces, or the entire length of the tooth).

For example, the width of conventional dental whitening strips typically incorporates a one-size fits-all design to accommodate the various sizes of teeth found in humans. Therefore by design, conventional dental whitening strips are configured such that the user folds any excess width, which cannot be fit on the front surface of the teeth, over to the back surface of the teeth. The excess width usually does not cover the entire back surface of the teeth, and thus does not provide an even treatment to the back surfaces of the teeth.

In addition, the length of existing whitening strips is designed to only cover teeth that are visible to casual onlookers. Existing dental strips usually cover from 1st bicuspid to 1st bicuspid of a human dental arch, and therefore do not usually cover teeth located in the back of the mouth (e.g., molars).

Due to the nature of dental whitening (e.g., users are mostly concerned about whitening visible portions of their teeth), the dental whitening strips discussed above offer a workable solution. However, many dental treatments (e.g., those other than whitening) require that the entire surface of every tooth be treated. Conventional dental strips are not sufficient to apply a uniform treatment to the entire surface of every tooth. Thus, other dental treatments rely on other application methods (e.g., customized trays) that are typically more costly and less convenient and comfort for the user, and often require the user to visit a dentist to receive the treatment.

Accordingly, there are a number of disadvantages in the conventional art of dental treatment strips.

### SUMMARY OF THE INVENTION

Example embodiments of the present invention include methods, devices, and systems that provide effective dental treatments to all tooth surfaces of the entire dental arch. In particular, embodiments of the present invention include treatment devices and systems that are capable of treating the entire arch by covering and delivering active ingredients to the front, back, and top surfaces of each of the teeth of the full dental arch. Moreover, example embodiments of the present invention provide treatment devices and systems that are capable of treating the gingival margin and gums of an entire arch.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example embodiment of a full arch dental treatment device according to one embodiment of the current invention;

FIG. 2 illustrates the top and bottom full arch of human teeth with a full arch dental treatment device applied, according to an example embodiment of the present invention;

FIG. 3 illustrates a side view of an example embodiment of the present invention applied to the front teeth and the back teeth;

FIG. 4A-4C illustrates various example embodiments of a full arch dental treatment device; and

FIGS. 5A-5F illustrate an example method of applying a full arch dental treatment device according to one example embodiment of the invention.

### DETAILED DESCRIPTION OF THE INVENTION

Example embodiments of the present invention include methods, devices, and systems that provide effective dental treatments to all tooth surfaces of the entire dental arch. In particular, embodiments of the present invention include treatment devices and systems that are capable of treating the entire arch by covering and delivering active ingredients to the front, back, and top surfaces of each of the teeth of the full dental arch. Moreover, example embodiments of the present invention provide treatment devices and systems that are capable of treating the gingival margin and gums of an entire arch.

As will be appreciated more fully herein, example embodiments of the present invention comprise the use of one or more full coverage treatment strips that are designed to cover and treat all surfaces of every tooth in the entire dental arch, so as to create a full arch treatment system. For example, the full arch treatment system of the present invention is designed to cover and deliver active ingredients to the front surface, the back surface, and top surface of the teeth of an entire dental arch. Additionally, the full arch treatment system can be configured to cover and deliver active ingredients to the front and back of the gingival margin and/or gums of an entire arch.

As an overview, example embodiments of the present invention incorporate the use of one or more full coverage treatment strips that are designed to be conveniently placed over specific sections of the dental arch. The full coverage treatment strips can include a backing layer that comprises a flexible thin film of plastic (or similar material) that acts as an insoluble barrier. A treatment composition is applied as a layer to one side of the backing layer. When applied to teeth, the treatment composition can act as a mild adhesive, allowing the treatment composition to stick to the teeth, while the backing layer acts as a barrier to saliva in order to protect the treatment composition from dilution.

The backing layer material can vary from one embodiment to the next, but generally includes flexible water insoluble sheets of material. For example, polymers can be formed into a sheet that is flexible and water insoluble. Many stiff polymers can be made flexible by the addition of plasticizers, and can therefore be modified to be used as the backing layer. The following list of polymers represent some example polymers that can be used to make the backing layer: polypropylene, polyethylene, polystyrene, acrylonitrile butadiene styrenes, polyester, polyethylene terephthalate, polyamides, polyurethanes, polyvinyl chlorides, paraffin waxes, waxes, modified waxy polymers, PARAFILM, polycarbonates, polyvinylidene chlorides, polymethyl methacrylates, polyetheretherketones, polytetrafluoroethylenes, polyetherimides, phenolics, polylactic acid, urea formaldehyde, melamine formaldehyde and/or any other like and useful polymer.

Notwithstanding the various types of backing layer material, the full arch treatment system can be configured to treat any number of dental conditions. For example, the full arch treatment system can incorporate any active ingredients that are useful for treating conditions found in the oral cavity, such as fluoride, anti-microbials, desensitizers, teeth whitening agents, re-mineralizers, periodontal agents, and/or any other useful active ingredient used to treat a dental condition. More than one active ingredient may be combined to provide a multi-treatment full arch treatment system.

Additionally, the active ingredient(s) can be used in conjunction with one or more inactive ingredients. For example, embodiments of the present invention can include thickeners, solvents, humectants, sweeteners, flavors and/or any other inactive ingredient that improves the delivery and compatibility of the active ingredients.

For example, thickeners can allow the active ingredients to essentially adhere to the treatment surface and reduce unwanted slippage of the full coverage treatment strips during treatment by means of increasing both the tackiness and viscosity of the treatment composition.

In addition, solvents provide a means of dissolving, suspending and liquefying chemical components that are usually solids at room temperature. Solvents can also be added as a means to adjust the viscosity of the treatment composition through evaporative drying. For example, the intentional selection of a volatile solvent can be added during the manufacturing process and then subsequently dried, leaving behind only the desired solvents, inactive ingredients, and active ingredients. This process, or similar processes, may be used to create treatment compositions of increased viscosity and tackiness.

Also, humectants can be added to minimize the complete dehydration of a given composition. Many active ingredients become inactive or unstable when they become dry, therefore humectants are added to keep the composition in a mobile or flexible state while preserving the stability and activity of the composition.

Furthermore, sweeteners and flavors can be added to the treatment composition to increase the palatability of the final composition. Sweeteners and flavors increase patient compliance to a prescribed treatment regime (e.g., treatment regimes that require extended wear times of more than about thirty minutes).

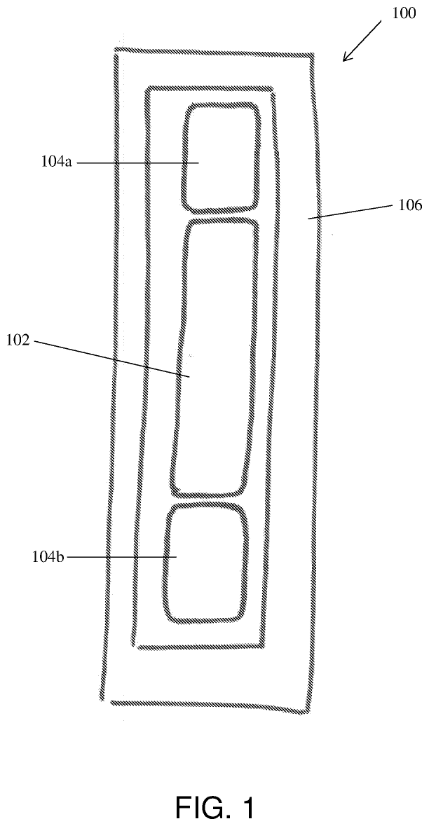

Referring now to FIG. 1, one example embodiment of the present invention comprises one or more full coverage treatment strips designed to easily and conveniently be applied to specific section of the dental arch. For example, FIG. 1 illustrates one example embodiment of a full arch treatment system 100 that includes three individual full coverage treatment strips. For purposes of this disclosure, “full coverage treatment strips” refers to dental treatment strips that have a width dimension great enough to fully cover the front surface, the back surface, and the top surface of a tooth in which the treatment strip is applied. Full coverage treatment strips can also include treatment strips that have a width great enough to cover the gingival margin and/or gums surrounding a particular tooth.

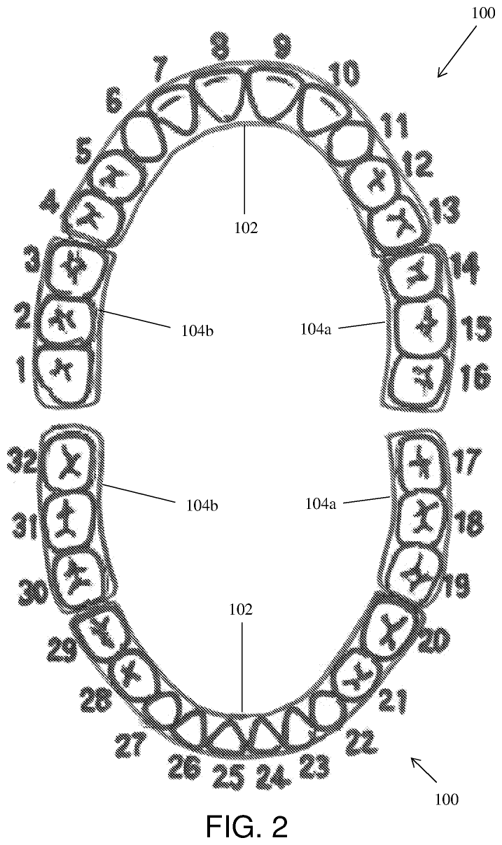

Returning to the Figures, FIG. 1 illustrates three full coverage treatment strips of various sizes, each designed for a specific anatomical section of the dental arch. The full coverage treatment strips are designed to be customizable and overlap onto each other in order to fit any dental arch. The full coverage treatment strips can, for example, include a front portion 102, and two back portions 104a and 104b. As shown in FIG. 1, the front portion 102 has a longer length compared to the two back portions 104a and 104b. Although the front portion 102 can have almost any length, in one example embodiment the length of the front portion 102 is between about two inches and about three inches and is configured to cover a front portion of the dental arch (see FIG. 2).

Conversely, the back portions 104a and 104b have a shorter length compared to the front portion, as illustrated in FIG. 1. For example, the back portions 104a and 104b can have a length of about one and one half inches or shorter (about the average combined width of a human index and middle finger), which is configured to cover a back portion of the dental arch (see FIG. 2). One reason the back portions 104a and 104b are shorter than the front portion 102 is that the back portions 104a and 104b are more difficult to apply due to cheek and tongue interference. Experimentation has demonstrated that when the back portions are much longer than the average combined width of about an index and middle finger, the back portions become more difficult to hold in the fingers and manipulate while applying to the back teeth. However, that same experimentation has indicated that three full coverage treatment strips, as explained above and illustrated in FIG. 1, allow a user to easily and conveniently apply the full coverage treatment strips to the entire dental arch.

FIG. 1 also illustrates that the three full coverage treatment strips can be positioned on a package 106 for shipment. Although the package 106 can take many forms, one example of the package 106 can include a release liner wherein the treatment composition of the three full coverage treatment strips is applied to the release liner. The release linger has less of an affinity to the treatment composition than does the backing layer, and therefore, a user can peel the full coverage treatment strips away from the release liner. Various other packages and packaging system may be used, such as those described in patent application Ser. Nos. 12/885,739 and 12/885,729, both of which are hereby incorporated in their entirety by reference.

FIG. 2 illustrates an example top and bottom full arch of human teeth with a full arch dental treatment system applied, according to the example embodiment discussed with reference to FIG. 1. As illustrated, the front portion 102 is applied to the front portion of the dental arch on both the top and bottom teeth. In particular, the front portion 102 can be applied from the right second bicuspid (tooth 4 on the top, and tooth 29 on the bottom) to the left second bicuspid (tooth 13 on the top, and tooth 20 on the bottom).

In alternative embodiments, the front portion 102 can cover more or less teeth than shown in FIG. 2, depending on the total length of the front portion 102, or depending on the particular dimensions of a user's teeth. However, the front portion 102 can be configured as one size-fits-all, such than when used in combination with the back portions 104a and 104b, the full dental arch of the user will be covered no matter the dimensions of a particular user's teeth. Alternatively, the front portion 102 dimensions can be customized for a particular user.

Similarly, FIG. 2 illustrates the back portions 104a and 104b are applied to the back portions of the dental arch on both the top and bottom teeth. In particular, FIG. 2 illustrates the back portions 104a and 104b can be applied from the third molar (tooth 1 and 16 on the top, and tooth 32 and 17 on the bottom) to the first molar (tooth 3 and 14 on the top, and tooth 30 and 19 on the bottom) on both the left and right sides of the dental arch.

In alternative embodiments, the back portions 104a and 104b can cover more or less teeth than shown in FIG. 2, depending on the total length of the back portions 104a and 104b, or depending on the particular dimension of a user's teeth. However, the back portions 104 can be configured as one size-fits-all, such that when used in combination with the front portion 102, the full dental arch of the user will be covered no matter the dimensions of a particular user's teeth. Alternatively, the back portions 104a and 104b dimensions can be customized for a particular user.

One way in which the full arch treatment system can be configured to fit the majority of users is to allow the front portion 102 and the back portions 104a and 104b to overlap when applied. For example, the front portion 102 and the back portions 104a and 104b can be configured such that they flex and overlap, and are therefore effectively customizable in order to fit the various shapes and sizes of the dental arch of various users.

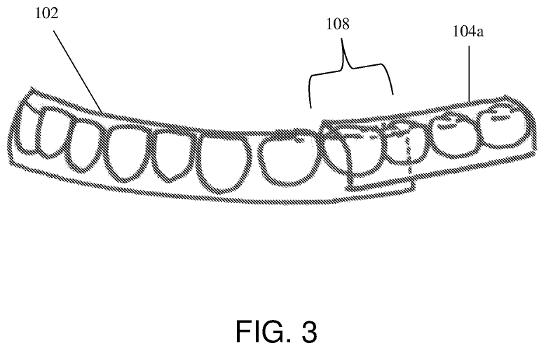

For example, FIG. 3 illustrates one example of how the front portion 102 and the back portion 104a can overlap to provide a customized fit. As illustrated, the front portion 102 can first be applied to the front portion of the teeth. Next, the back portion 104a can be applied to the back portion of the teeth. By design, and due to the predetermined lengths of both the front portion 102 and the back portion 104a, the front portion 102 and the back portion 104a create an overlap zone 108, as illustrated in FIG. 3. The overlap zone 108 ensures that the full dental arch is covered by at least one or more full coverage treatment strips. In alternative embodiments, the front portion can overlap the back portion if the back portion is applied to the dental arch first.

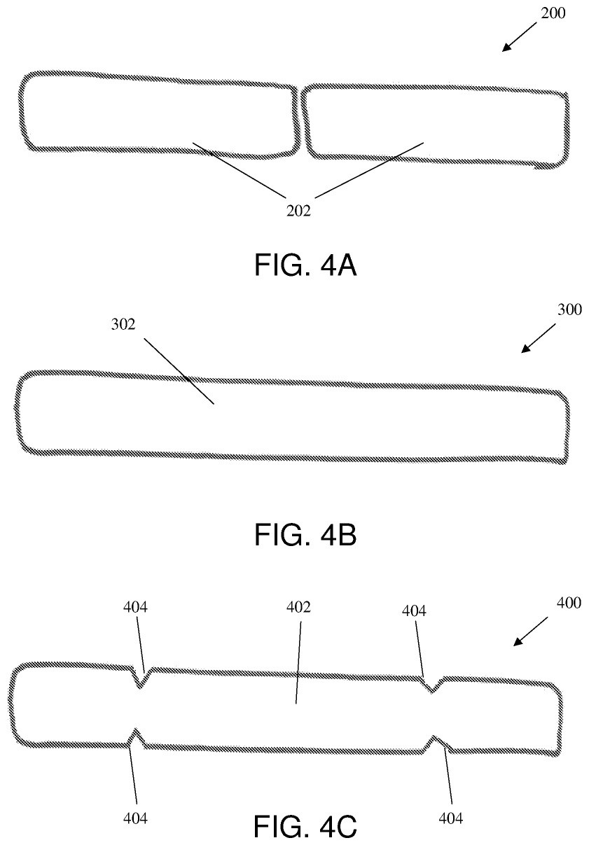

Notwithstanding the above mentioned features and characteristics, the present invention can encompass various other characteristics and features that provide a full arch treatment strip. For example, FIG. 4A illustrates one example alternative of a full arch treatment system 200 that includes two substantially equally sized full coverage treatment strips 202. The full coverage treatment strips 202 can be sized and configured such that they overlap near the front of the dental arch, and therefore provide a full arch dental treatment system similar to the system explained above.

FIG. 4B illustrates an example embodiment of a full arch treatment system 300 that uses a single full coverage treatment strip 302. The single full coverage strip 302 can be usefully used as a dental treatment strip when a dental technician, or at least another person besides the user, applies the single full coverage treatment strip 302. Moreover, a user can also apply the single full coverage treatment strip 302 if the user has access to cheek retractors.

For example, a dentist, or a user with cheek retractors, can move the cheeks away from the teeth and gain reasonable access to the back teeth and apply the single full arch treatment strip 302 successfully. Therefore, the present invention also incorporates the combination of cheek retractors and any single or multiple full coverage treatment strips into a full arch treatment kit.

FIG. 4C illustrates yet another embodiment of a full arch treatment system 400. As with FIG. 4B, the full arch treatment system comprises a single full coverage treatment strip 402. In addition, however, the full coverage treatment strip 402 can include one or more notches 404 that allow the full coverage treatment strip 402 to bend and fold around the dental arch of a user. For example, the one or more notches 404 can be located on the full coverage treatment strip 402 in a location where the dental arch of the user has a minimum curve radius. The notches 404 allow portions of the full coverage treatment arch 402 to overlap itself, without creating folds or creases.

Although not illustrated, other full arch treatment systems are also within the scope of the present invention. For example, additional embodiments can incorporate the use of four or more strips (e.g., multiple molar strips). In particular, a full arch treatment system can include four full coverage strips of equal or varying lengths.

The present invention can also include multiple full arch treatment systems that incorporate one or more strips of equal or varying sizes designed to deliver a specific ingredient or ingredients in the most advantageous means possible and for specific purposes. For example, full arch treatment systems can be configured to provide a fluoride treatment to the full dental arch, and also provide a desensitizing treatment to only a particular tooth or portion of the dental arch. In one example, a full coverage treatment strip can have different zones of active ingredients such that various different treatments can be applied at the same time and by the same strip, but to different zones of the full dental arch.

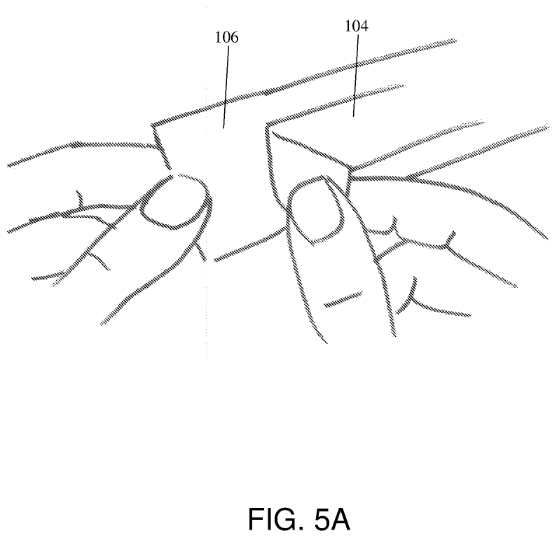

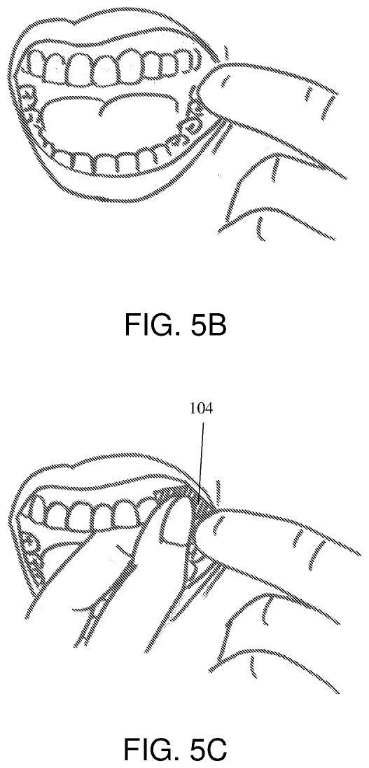

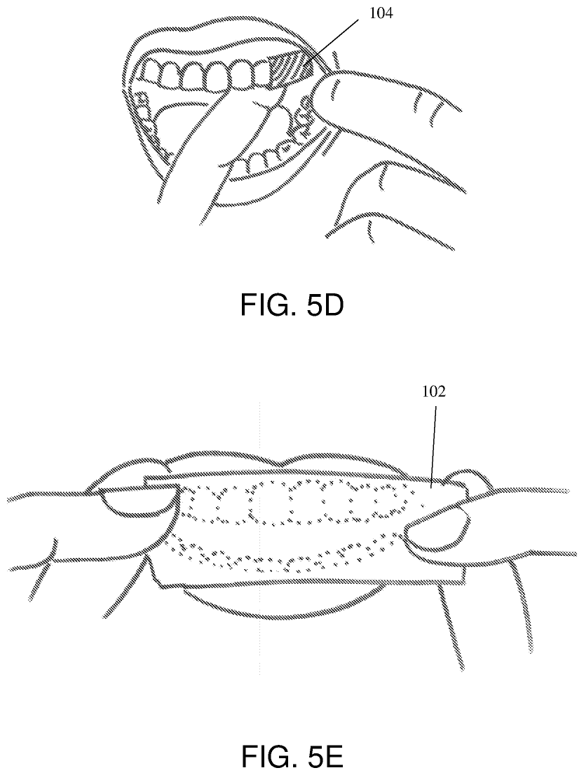

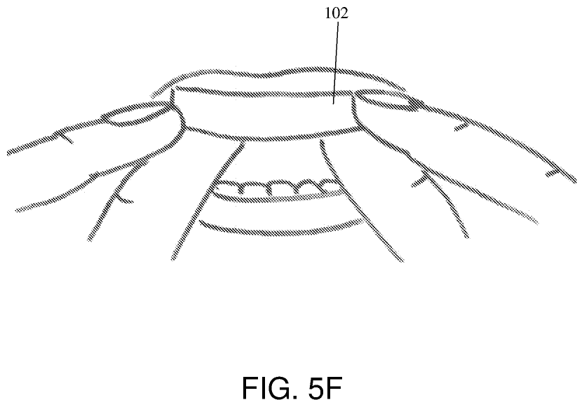

FIGS. 5A through 5F illustrate an example method of applying the full arch treatment system 100 as explained with reference to FIG. 1. As illustrated, the method can apply the two back portions 104a to the back molars first, followed by applying the front portion 102 to the remaining teeth with any excess film overlapping onto the already applied molar strips. This order, however, can be reversed if desired.

In particular, FIG. 5A illustrates that a first step can include removing the back portion 104 from the packaging 106. In particular, the user can grasp a corner of the back portion 104 and peel the back portion 104 away from the packaging 106 using one hand.

Moving to FIG. 5B, the user can use their other hand (i.e., the hand not holding the back portion 104, to gain access to one side of molars. For example, and as illustrated in FIG. 5B, a user can use the index finger to retract the cheek and expose the molars.

Once the cheek is retracted, the user can insert the back portion 104 into the mouth, as illustrated in FIG. 5C. Upon inserting the back portion 104 into the mouth, the user can then apply the back portion to the front surface (i.e., the surface facing the cheek) of the molars and press until it attaches.

Once the back portion 104 is attached to the front surface of the molars, the user can proceed by folding the remainder of the back portion 104 around the occlusal to the lingual side and press until firmly fitted, as illustrated in FIG. 5D. The steps explained with reference to FIGS. 5A through 5D is then repeated for the other side of the arch.

As illustrated in FIG. 5E, when both back portions 104 are fit in place, the user can grasp the front portion 102 at each end between the thumb and index/middle finger of each hand. While exposing the front surface of the front teeth, the user can apply the front portion 102 to the remaining front teeth, remembering to overlap any excess onto the back portions 104.

Once the front portion 102 is stuck or applied to front of the teeth fold the remainder of the strip around the occlusal to the lingual side and press until firmly fitted, as illustrated in FIG. 5F.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of treating surfaces of a dental arch, said arch comprising a central front portion and two lateral rear portions, the method comprising:
a central arch treatment step of affixing a central treatment strip to the front portion of said dental arch; and,
a lateral arch treatment step of affixing two lateral treatment strips to the lateral rear portions of the arch;
wherein at least one incisor is covered by the central treatment strip and at least one molar is covered by each of the lateral treatment strips.

2. The method of treating surfaces of a dental arch of claim 1, the central treatment strip being longer than the lateral treatment strips.

3. The method of treating surfaces of a dental arch of claim 1, the central treatment strip overlapping with both lateral treatment strips when the central and lateral treatment strips are affixed to the dental arch.

4. The method of treating surfaces of a dental arch of claim 1, the central and lateral treatment strips being whitening strips.
